(19) United States
(12) Patent Application Publication
(10) Pub. No.: US 2018/0012411 A1
(43) Pub. Date: Jan. 11, 2018

(54) Augmented Reality Methods and Devices

(71) Applicant: Gravity Jack, Inc., Liberty Lake, WA (US)

(72) Inventors: Aaron Luke Richey, Liberty Lake, WA (US); Randall Sewell Ridgway, Spokane, WA (US); Shawn David Poindexter, Coeur d'Alene, ID (US); Marc Andrew Rollins, Spokane Valley, WA (US); Joshua Adam Abel, Spokane, WA (US)

(73) Assignee: Gravity Jack, Inc., Liberty Lake, WA (US)

(21) Appl. No.: 15/645,887

(22) Filed: Jul. 10, 2017

Related U.S. Application Data
(60) Provisional application No. 62/360,889, filed on Jul. 11, 2016.

(51) Int. Cl. G06T 19/00

(52) U.S. Cl. CPC G06T 19/006; G06T 7/73; G06T 2207/20084; G06T 2207/20081

(57) ABSTRACT

Augmented reality methods and systems are described. According to one aspect, an augmented reality computer system includes processing circuitry configured to access an image of the real world, wherein the image includes a real world object, and evaluate the image using a neural network to determine a plurality of augmented reality estimands which are indicative of a pose of the real world object and which are useable to generate augmented content regarding the real world object. Other methods and systems are disclosed including additional aspects directed towards training and using neural networks.

### RELATED PATENT DATA

This application claims the benefit of U.S. Provisional Patent Application Ser. No. 62/360,889, filed Jul. 11, 2016, titled “Estimating Object Pose, Lighting Environment, and an Object's Physical State in Images and Video Including Use of Deep Neural Networks”, the disclosure of which is incorporated herein by reference.

### TECHNICAL FIELD

This disclosure relates to augmented reality methods and systems.

### BACKGROUND OF THE DISCLOSURE

Maintenance and repair of machines and equipment can be costly. The United States auto repair industry generates $62 billion in annual revenue. The global market for power plant maintenance and repair is a $32 billion industry. The global wind turbine operations and maintenance market is expected to be worth $17 billion by 2020. A significant part of these costs include education, training, and subsequently, retraining of the personnel involved in these industries at every level. Training of these personnel often requires travel and dedicated classes. As machines and techniques are updated, personnel may need to be retrained. Currently, reference material is typically accessed as a manual, with written steps and figures—a solution that satisfies only one of the five primary styles of learning and comprehension (visual, logical, aural, physical and verbal).

Example aspects of the disclosure described below are directed towards use of display devices to generate augmented content which is displayed in association with objects in the real or real world. In some embodiments described below, the augmented content assists users with performing tasks in the real world, for example with respect to a real world object, such as a component of a machine being repaired. A neural network is utilized to generate estimands of an object in an image which are indicative of one or more of poses of the object, lighting of the object and state of the object in the image. The estimands are used to generate augmented content with respect to the object in the real world. Additional aspects are also discussed in the following disclosure.

### BRIEF DESCRIPTION OF THE DRAWINGS

Example embodiments of the disclosure are described below with reference to the following accompanying drawings.

FIG. 1 is an illustrative representation of augmented content associated with a real world object according to one embodiment.

FIG. 2 is an illustrative representation of neurons of a neural network according to one embodiment.

FIG. 3 is a functional block diagram of a process of training a neural network.

FIG. 4 is an illustrative representation of neurons of a neural network with output estimands indicative of object pose, lighting and state according to one embodiment.

FIG. 5 is a flowchart of a method of collecting backgrounds and reflection maps according to one embodiment.

FIG. 6 is a flowchart of a method of generating foreground images according to one embodiment.

FIG. 7 is a flowchart of a method of an augmentation pipeline according to one embodiment.

FIG. 8 is a flowchart of a method of initializing a neural network according to one embodiment.

FIG. 9 is a flowchart of a method of training a neural network with training images according to one embodiment.

FIG. 10 is a flowchart of a method for tracking and detecting an object in photographs or video frames of the real world according to one embodiment.

FIG. 11 is an illustrative representation of utilization of a virtual camera to digitally zoom into a camera image according to one embodiment.

FIG. 12 is a functional block diagram of a display device and server used to generate augmented content according to one embodiment.

FIG. 13 is a functional block diagram of a computer system according to one embodiment.

### DETAILED DESCRIPTION OF THE DISCLOSURE

This disclosure is submitted in furtherance of the constitutional purposes of the U.S. Patent Laws “to promote the progress of science and useful arts” (Article 1, Section 8).

As mentioned above, some example aspects of the disclosure are directed towards use of display devices to display augmented content which is associated with the real world. More specific example aspects of the disclosure are directed towards generation and use of the augmented content to assist users with performing tasks in the real or real world, for example with respect to an object in the real world. In some embodiments discussed below, display devices are used to display augmented content which is associated with objects in the real world, for example to assist personnel with maintenance and repair of machines and equipment in the real world.

Augmented content may be used to assist workers with performing tasks in the real world in some example implementations. If a maintenance or repair worker could go to work on a machine and see each sequential step overlaid as augmented content on the machine as they work, it would increase the efficiency of the work, improve complete comprehension, reduce errors, and lower the training and education requirements—ultimately, drastically reducing costs on a massive scale.

Augmented reality (AR) is a tool for providing augmented content which is associated with the real world. As mentioned above, in some embodiments, the augmented content (e.g., augmented reality content), may be associated with one or more objects in the real world. As described below, the augmented content is digital information which may include graphical images which are associated with the real world. In addition, the augmented content may include text or audio which may be associated with and provide additional information regarding a real world object and/or virtual object.

Training and education are illustrative examples of the use of augmented reality. Some other important applications of augmented reality include providing assembly instructions, product design, directions for part picking, marketing, sales, article inspection, identifying hazards, driving/flying directions and navigation, although aspects of the disclosure may be utilized in additional applications. Augmented reality (AR) allows a virtual object which corresponds to an actual object in the real world to be seamlessly inserted into visual depictions of the real world in some embodiments. In some implementations discussed below, information regarding an object in an image of the real world, such as pose, lighting, and state, may be generated and used to create realistic augmented content which is associated with the object in the real world. In addition, neural networks including deep neural networks may be utilized to generate the augmented content in some embodiments discussed below.

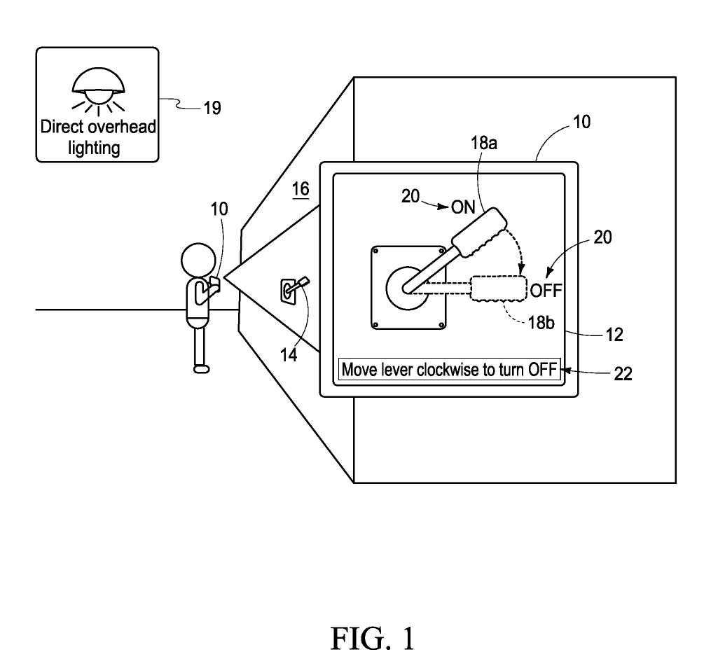

Referring to FIG. 1, one example application of the use of augmented content in the real world is shown. In one embodiment, the view of the real world is seen through a video feed generated and displayed using a display device 10 that can augment reality in the video feed with augmented content. Example display devices 10 include a camera (not shown) which generates image data of the real world and a display 12 which can generate visual images including the real world and augmented content which are observed by a user. More specifically, example display devices 10 include a tablet computer as shown in FIG. 1 although other devices may be utilized such as a head mounted display (HMD), smartphone, projector, etc. may be used to generate augmented content.

A user may manipulate device 10 to generate video frames or still images (photographs) of a real world object in the real world. The device 10 or other device may be used to generate augmented content for example which may be displayed or projected with respect to the real world object. In FIG. 1, the real world object is a lever 14 mounted upon a wall 16. The user may control device 10 such that the lever 14 is within the field of view of the camera (not shown) of the device 10. Display device 10 processes image data generated by the camera, detects the presence of the lever 14, tracks the lever 14 in frames, and thereafter generates augmented content which is displayed in association with the lever 14 in images upon display 12 and/or projected with respect to the real world object 14 for observation by a user.

The display of the augmented content may be varied in different embodiments. For example, the augmented content may entirely obscure a real world object in some implementations while the augmented content may be semitransparent and/or only partially obscure a real world object in other implementations. The augmented content may also be associated with the object by displaying the augmented content adjacent to the object in other embodiments.

In the example shown in FIG. 1, the augmented content within images displayed to the user includes a virtual lever in a position 18a which has a shape which corresponds to the shape of the real world lever 14 and fully obscures the real world lever 14 in the image displayed to the user. The augmented content also includes animation which moves the virtual lever from position 18a to position 18b, for example as an instruction to the user.

The example augmented content also includes text 20 which labels positions 18a, 18b as corresponding to “on” and “off” positions of the lever 14. Furthermore, the example augmented content additionally includes instructive text 22 which instructs the user to move lever 14 to the “off” position. In one embodiment, the virtual lever in position 18a completely obscures the real world lever 14 while the real world lever 14 is visible once the virtual lever moves during the animation from position 18a towards position 18b.

As discussed herein, a CAD or 3D model of an object may exist and be used to generate renders of the object for use in training of a neural network. The CAD or 3D model may include metadata corresponding to the object, such as tags which are indicative of a part number, manufacturer, serial number, and/or other information with respect to the object. In one embodiment, the metadata may be extracted from the model and included as text in augmented content which is displayed to the user.

In order for the augmented content to be properly aligned with a real world object, the position and orientation of the object are measured relative to the digital display, projector or camera in some embodiments. When this alignment is performed with a camera sensor it is often called three-dimensional pose estimation or “6-Degree-of-Freedom”/“6DofF” pose estimation (hereafter pose estimation). Pose estimation is the process of determining the transformation of an object in a two-dimensional image which gives the three-dimensional object relative to the camera (i.e. object pose). The pose may have up to six degrees of freedom. The problem is equivalent to finding the position and rotation of the camera in the coordinate frame of the object (i.e. camera pose). Determination of the object pose herein also refers to determination of camera pose relative to the object since the poses are inversely related to one another. In some AR applications, it may only be important to know where an object is in image space instead of in three-dimensional space. When a pose is used, we refer to this as pose-based AR. When one only uses the information about where the object is in image space, we call this pose-less AR.

Pose estimation is difficult to perform in general with traditional computer vision techniques. Objects that are textured planes with matte finishes work very well with popular techniques. Some techniques exist for doing pose estimation on non-planar objects, but they are not as robust as desired for ubiquitous AR use cases. This is largely because the observed pixel values are a combination of the intrinsic appearance of the object combined with extrinsic factors of variation. These factors include but are not limited to environmental lights, reflections, external shadows, self-shadowing, dirt, weather and camera exposure settings. It is challenging to hand-design algorithms that can estimate the pose given an image of the object, regardless of texture, finish and the extrinsic factors of variation.

An important aspect of augmented reality is matching the lighting environment of the augmented content with the lighting upon the real world objects. When the lighting is different between each, the augmented content is not as believable and may be distracting. Some aspects of the disclosure determine the location, direction and type of light in the real world from an image and use the determined information regarding lighting to create the augmented content in a similar way for a more seamless AR experience. In some embodiments, it is determined if the light source illuminating the real object is a point source, ambient light, or a combination along with the light direction. Referring again to FIG. 1, the type of light (e.g., direct overhead lighting) and direction of light from a light source 19 in the real world may be determined and utilized to generate the augmented content including a virtual object having lighting which corresponds to lighting of the object in the real world.

Additionally, if the physical state (e.g. shape, position or color) of an object can change, the augmented content can be adjusted to adapt to these changes for proper alignment depending on the AR application. In the above-described example, a real world object may be a lever 14 that moves. A user may need to understand if the lever is in the open/on or closed/off position so the proper instructions can be rendered in augmented content. In another example, an object may have an indicator that changes color. These physical states are important to understand the context of the object, such as when doing maintenance or repair.

The following disclosure provides example solutions for enabling computer vision based AR to work on any object in the real world. In some embodiments discussed herein, deep neural networks are used to implement the computer vision based AR. In addition, the following disclosure demonstrates how to train these networks so they can be applied to evaluate still images and video frames of objects to estimate pose, physical state and the lighting environment in some examples.

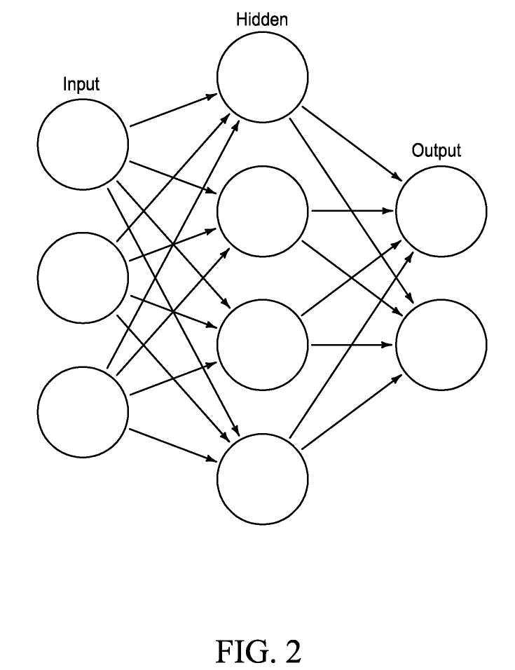

Artificial neural networks (hereafter networks) are a family of computational models inspired by the biological connections of neurons in the brains of animals. Referring to FIG. 2, an example neural network is shown including a set of input and output neurons, and hidden neurons that altogether form a directed computation graph that flows from the input neurons to the output neurons via the hidden neurons. Hereafter, the set of input neurons will be referred to as the input layer and the set of output neurons will be referred to as the output layer.

Each edge (or connection) between neurons has an associated weight. An activation function for each non-input neuron specifies how to combine the weighted inputs. There is a learning rule that determines how the weights are updated as the network learns to generalize its prediction based on a set of training data. The network is used to predict an output by feeding data into the input neurons and computing values through the graph to the output neurons. This process is called feedforward. The training process typically utilizes both the feedforward process followed by a learning algorithm (usually backpropagation) which computes the difference between the network output and the true value, via a loss function, then adjusts the weights so that future feedforward computations will more likely arrive at the correct answer for any given input. In other words, the goal is to learn from examples, referred to as training images below. This is known as supervised learning. It is not uncommon to apply millions of these training events for large networks to learn the correct outputs.

Deep learning is a subfield of machine learning where a set of algorithms are used to model data in a hierarchy of abstractions from low-level features to high-level features. In the context of this disclosure, an example of a feature is a subset of an image used to identify what is in the image. A feature might be something as simple as a corner, edge or disc in an image, or it can be as complex as a door handle which is composed of many lower-level features. Deep learning enables machines to learn how to describe these features instead of these features being described by an algorithm explicitly designed by a human. Deep learning is modeled with a deep neural network which usually has many hidden layers in some embodiments.

Deep neural networks often will have various structures and operations which make up their architecture. These may include but are not limited to convolution operations, max pooling, average pooling, inception modules, dropout, fully connected, activation function, and softmax. Convolution operations perform a convolution of a 2D layer of neurons with a 2D kernel. The kernel may have any size along with a specified stride and padding. Each element of the kernel has a weight that is fit during the training of the network. Max pooling is an operation that takes the max of a sliding 2D window over an 2D input layer of neurons with a specified stride and padding. Average pooling is an operation that takes the average of a sliding 2D window over an 2D input layer of neurons with a specified stride and padding. An inception module is when several convolutions with different kernels are performed in parallel on one layer with their outputs concatenated together as described in the reference incorporated by reference above. Dropout is an operation that randomly chooses to zero out the weights between neurons with a specified probability (usually around 0.5), essentially severing the connection between two neurons. A fully connected layer is one where every neuron in one layer is connected to every neuron in the following layer. An activation function is often a nonlinear function applied to a linear combination of the input neurons. Softmax is a function which squashes a K-dimensional vector of real values so that each element is between zero and one and all elements add to one. Softmax is typically the last operation in a network that is designed for classification problems.

For some networks to properly make predictions they need to have training data from which to learn from. Deep neural networks in particular may utilize a significant amount of training data that are labeled with the correct output. Some additional examples of known deep neural networks and what they have accomplished follows. AlexNet described in Krizhevsky, Alex, Ilya Sutskever, and Geoffrey E. Hinton, “ImageNet Classification with Deep Convolutional Neural Networks,” In Advances in Neural Information Processing Systems 25, 2012, edited by F. Pereira, C. J. C. Burges, L. Bottou, and K. Q. Weinberger, p. 1097-1105, the teachings of which are incorporated by reference herein, was one of the first deep neural networks to outperform hand crafted feature sets in image classification. Another deep neural network is discussed in Mnih, Volodymyr, Koray Kavukcuoglu, David Silver, Andrei A. Rusu, Joel Veness, Marc G. Bellemare, Alex Graves, et al., “Human-Level Control through Deep Reinforcement Learning.” Nature, 2015, Nature Publishing Group, pp. 529-33 which teaches computers to play video games from raw screen data.

Some embodiments disclosed herein describe how to build a deep neural network along with procedures for training and using the network to estimate the pose, lighting environment, and physical state of an object as seen in an still image (e.g., photographs) or sequence of images (e.g., video frames), which may also be referred to as camera images which are images of the real world captured by a camera. Classification neural networks are described which learn how to detect and classify an object in an image as well as augmented content neural networks which generate estimands of one or more of object pose (or camera pose relative to the object), lighting, and state of the object which may be used to generated augmented content.

Tracking an object is estimating its location in a sequence of images. The network performs a regression estimate of the values of pose, lighting environment, and physical state of an object in one embodiment. Regression maps one set of continuous inputs (x) to another set of continuous outputs (y). A neural network may additionally perform binary classification to estimate if the object is visible in the image so that the other estimates are not acted upon when the object is not present since the network will always output some value for each output. For brevity, we collectively refer to the network's estimate of pose, physical state, lighting environment, and presence as the estimands. Depending on the application, the estimands may be all of these outputs or a subset of them. In some embodiments, the network is not trying to classify the pose from a finite set of possible poses, instead it estimates a continuous pose given an image of a real world object in the real world in some embodiments. In some embodiments, training of the network may be accomplished by either providing computer generated images (i.e. renders) or photographs of the object to the neural network. The real world object may be of any size, even as large as a landscape. Also, the real world object may be entirely seen from within the inside where the real world object surrounds the camera in the application.

One embodiment of the disclosure generalizes the AR related challenges of pose estimation, lighting environment estimation, and physical state estimation to work on any kind of real world object. Even objects that have highly reflective surfaces may be trained. This is achieved because with enough data, the neural network will learn how to create robust features for measuring the relevant properties despite the extrinsic environmental factors mentioned earlier such as lighting and reflections. For example, if the object is shiny or dirty, the neural network may be prepared for these conditions by training it with a variety of views and conditions.

There are an infinite number of possible network architectures that may be constructed to classify objects and output the estimands. Principles for constructing example networks are discussed below along with examples of how to generate training data for the networks and how to utilize the neural network for implementing augmented reality in some implementations. The disclosure proceeds with examples about two types of neural networks discussed above including an augmented content network which computes the above-described estimands and a classification network for classifying real world objects in images in some embodiments. A single network may perform both classification operations as well as operations to calculate the above-described estimands for augmented reality in some additional embodiments. In some implementations, the network generates augmented reality estimands for generating augmented content and classification is not performed.

In one example, the classification network may be used to first classify one or more real world objects within an image, and based upon the classification, one or more augmented content networks may be selected from a database and which correspond to the classified real world objects in an image. The augmented content network(s) estimate the respective augmented reality estimands for use in generating the augmented content which may be associated with the classified real world object(s). For example, if lever is identified in an image by the classification network, then an augmented content network corresponding to the lever may be selected from a database, and utilized to calculate the estimands for generating augmented content with respect to the lever. The estimands may be used to generate the augmented content in accordance with the object included in the images captured by a display device 10. For example, the generated augmented content may include a virtual object having a pose, lighting and state corresponding to the pose, lighting and state of the object in the camera image.

In one embodiment, the classification and augmented content neural networks each include an input layer, one or more hidden layers, and an output layer of neurons. The input layer maps to the pixels of an input camera image of the real world. If the image is a grayscale image, then the intensities of the pixels are mapped to the input neurons. If the image is a color image, then each color channel may be mapped to a set of input neurons. If the image also contains depth pixels (e.g. RGB-D image) then all four channels may also be mapped to a set of input neurons. The hidden layers may consist of neurons that form various structures and operations that include but are not limited to those mentioned above. Parts of the connections may form cycles in some applications and these networks are referred to as recurrent neural networks. Recurrent neural networks may provide additional assistance in tracking objects since they can remember state from previous video frames. The output layer may describe some combination of augmented reality estimands: the object pose, physical state, environment lighting, the binomial classification of the presence of the object in the image, or even additional estimands that may be desired.

In one embodiment, the pose estimation from an augmented content network is a combination of the position and rotation of a real world object in coordinates of the camera. In another embodiment, the pose estimation is the position and rotation of the camera in the coordinates of the real world object. These are equivalent in that one measures the inverse of the other. If, for example, Cartesian coordinates are used for location and quaternions are utilized for rotation, then the pose estimate consists of seven output neurons (i.e., 3 for position and 4 for rotation). In one embodiment, position neurons are fully connected to the previous layer, and the rotation neurons are also fully connected to the previous layer. If the real world object of interest has symmetry, then it may be helpful to utilize a coordinate system other than Cartesian, such as polar or spherical coordinates when describing the position component of the pose, and one or more of the coordinates may be dropped from the architecture and training. For example, if the real world object has radial symmetry, it may be useful to consider the object in cylindrical coordinates where the axis of symmetry is centered on and parallel to the height axis. This reduces the positional parameters from three to two: radial distance and azimuth in cylindrical coordinates. In another example, the object may have spherical symmetry or approximate spherical symmetry where the specific rotation is not relevant to the application. Spherical coordinates may be used in this case where the angular components are dropped leaving only the radial distance parameter for the positional pose parameter.

An object's physical state (e.g., position, shape, color, etc.) may vary and it may be important to measure the current state in the real world. For example, a real world object may have one or more parts that move (e.g. lever, door, or wheel) or change position. The object may move between discrete shapes or morph continuously. The color of part or all of the object may also change. An augmented content network may be modeled to predict the physical state of the machine. For example, if the machine has a lever that can be in an open or closed state, then this may be modeled with a single neuron that outputs values between zero and one. If there are a combination of movable parts then each of these may have one or more neurons assigned to those movements. Color may be modeled with either binary changes or a combination of neurons representing the color channels for each part of the object that may change color in an additional illustrative example.

The environmental lighting configuration may be modeled with the augmented content network. In one embodiment, if the real world object is expected to be seen predominately under ambient lighting conditions then a neuron may model the intensity of light from a predetermined solid angle relative to the real world object. In another embodiment, a real world object may be illuminated with a directional light, such as the sun or a bare light bulb. This directional light may be modeled as a rotation around the coordinate system of the object. In other embodiments, it may be necessary to model the distance to the light when the extent of the object is of similar size or larger compared to the light source distance. A quaternion represented by four neurons outputs may specify the direction from which the object is lit and augmented reality estimands may also include the location of the light source which may be referred to as pose of the lighting. In other cases, a combination of any of these lighting conditions might exist, and both sets of neurons can be used to model and estimate the observed values as well as an output neuron to represent their relative contributions to the illumination.

In one embodiment, the presence of a real world object in the image may be modeled with a single neuron with a softmax activation that outputs a value between zero and one representing the confidence of detection. This helps prevent a scenario where the application forces a digital overlay for some output pose of the object when the real world object is not present in the image since it will always output an estimate for each of the estimands. Each application may require a different combination of these output neurons depending on the application requirements.

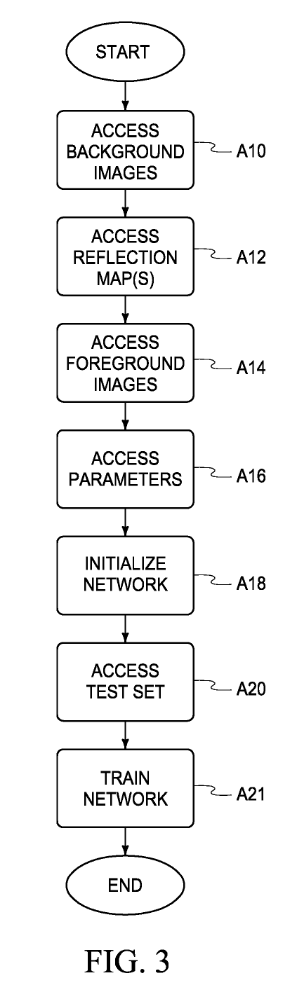

Referring to FIG. 3, an example process for creating classification and/or augmented content networks is described according to one embodiment. The process may be performed using one or more computer system. Other methods are possible in other embodiments including more, less and/or alternative acts.

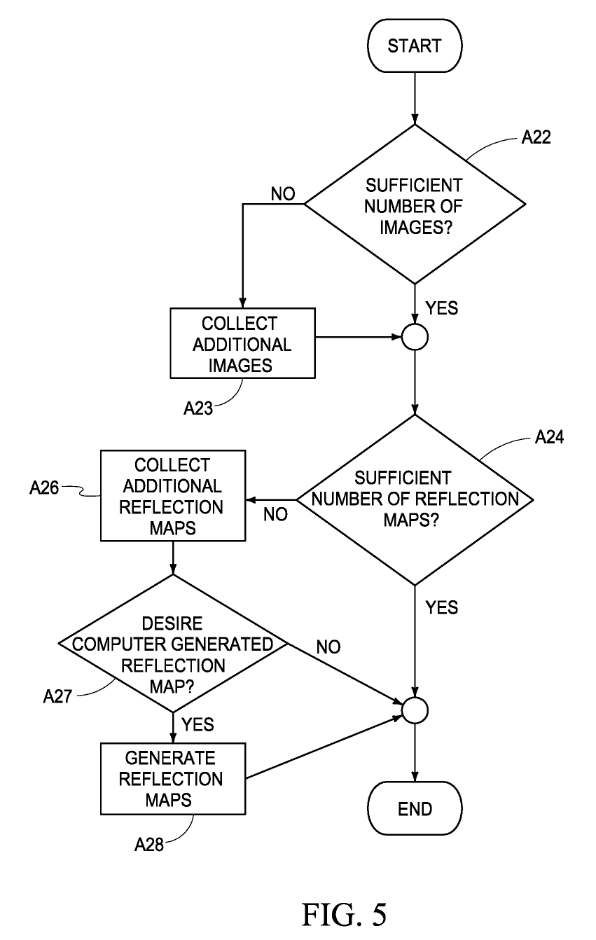

At acts A10 and A12, a plurality of background images and a plurality of reflection maps are accessed by the computer system. For objects that can be seen in multiple locations and potentially multiple environments it is desired in some embodiments that the network learn to ignore the information surrounding the object. One example of a real world object where the surroundings could change would be a tank. The tank could be seen in many types of locations, in a desert, in a city, or within a museum. An example of where an environment might change would be the Statue Of Liberty. The statue is always there but the surrounding sky may appear different, and buildings in the background can change. To train the network to ignore the backgrounds in these situations, a large collection of images (e.g., 25,000 or more) and environment maps (e.g., 10 more or less) may be used in one embodiment. Additional details regarding acts A10 and A12 are discussed below with respect to FIG. 5.

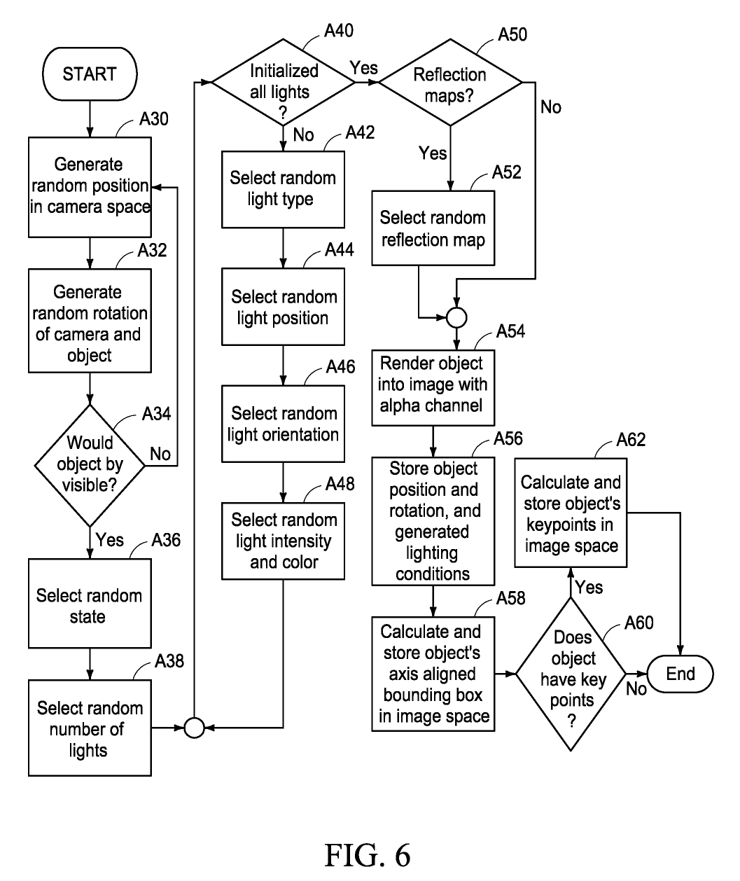

At an act A14, the computer system accesses a plurality of images of the real world object. These images of the real world object may be referred to as foreground images. The foreground images may include still images of the real world object (e.g., photographs and video frames) and/or computer generated renderings of a CAD or 3D model of the real world object. Additional details regarding act A14 are discussed below with respect to FIG. 6 according to an example embodiment of the disclosure.

At an act A16, some parameters may be entered by a user, such as viewing and state parameters of the object, environment parameters to simulate, settings of the camera (e.g., field of view, depth of field, etc.) which was used to generate the images to be processed, etc.

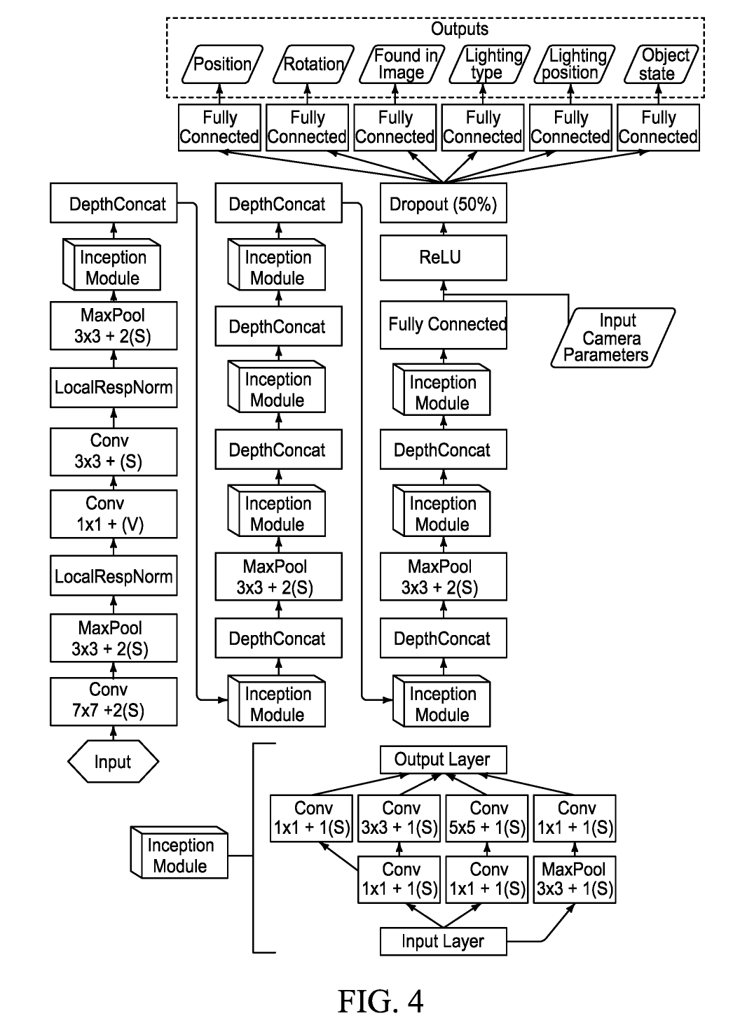

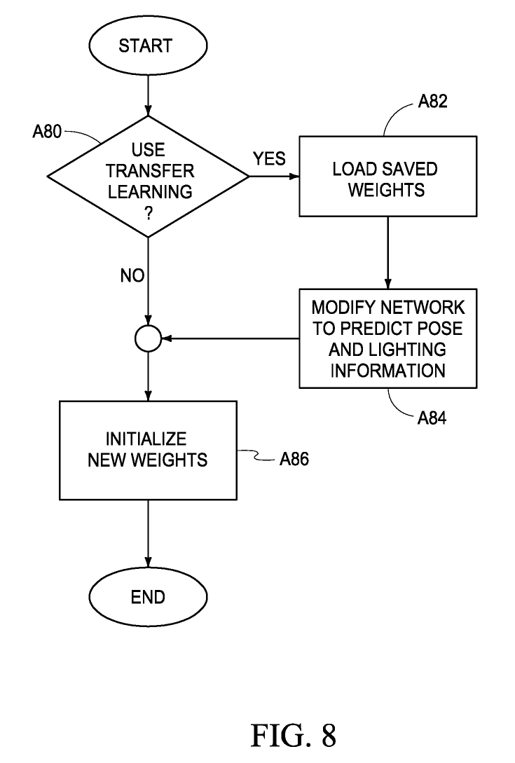

At an act A18, a network having a desired architecture to be trained for performing classification of an object and/or generation of AR data for the object (e.g., augmented reality estimands for position, rotation, lighting type, lighting position/direction and/or physical state of the object which may be used to generate augmented content) is selected and initialized. There are an infinite number of ways to construct an augmented content or classification network which may be utilized to implement aspects of the disclosure. In one embodiment, the network may be a modified version of the GoogLeNet convolutional neural network which is described in Szegedy Christian, Liu Wei, Jia Yangqing, Sermanet Pierre, Reed Scott, Anguelov Dragomir, Erhan Dumitru, Vanhoucke Vincent, and Rabinovich Andrew. 2015. “Going Deeper with Convolutions.” In 2015 IEEE Conference on Computer Vision and Pattern Recognition (CVPR), the teachings of which are incorporated herein by reference. Other network architectures may be used in other embodiments. Additional details regarding an example network which may be used for classification and/or calculating augmented content are described below with respect to FIG. 4 and a process for initializing a network are discussed below with respect to FIG. 8. In one initialization example, default weights are assigned to connections of the network, or previously saved weights may also be used if transfer learning is being utilized.

At an act A20, a set of test images of background images and foreground images are accessed. In one embodiment, the test images are not used for network training, but rather are used to test and evaluate the progress of the training of the network using a plurality of training images for classification and/or calculating AR estimands described below. The training images may include renders of an object using a CAD or 3D model and photographs and/or video frames of the object in the real world in example embodiments. Approximately 10% of the training images are randomly selected and reserved as a set of test images in one implementation.

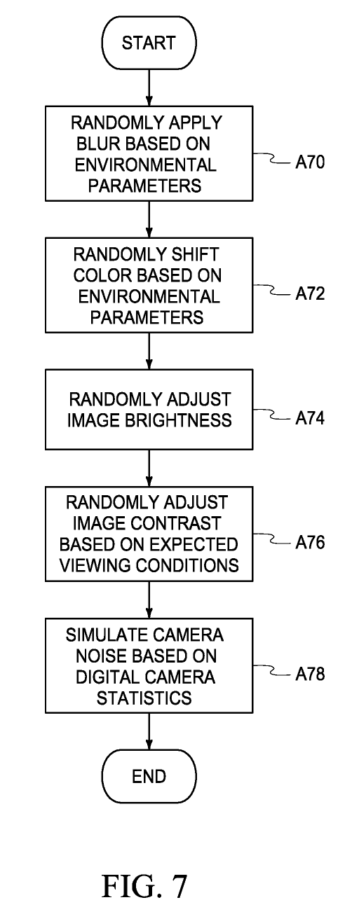

In one embodiment, an image of the training or test set is generated by compositing one of the foreground images with a random one of the background images where the object of interest is superimposed upon one of the background images. In one embodiment, a background image is randomly selected and randomly cropped to a region the size the network expects. For example if the network expects an image size of 256×256 pixels, a square could be cropped in the image starting from the point (10,30) and ending at (266, 286). After compositing, the training or test image may be augmented, for example as described below with respect to FIG. 7. Additional test or training images may be generated by compositing the same foreground image with different background images.

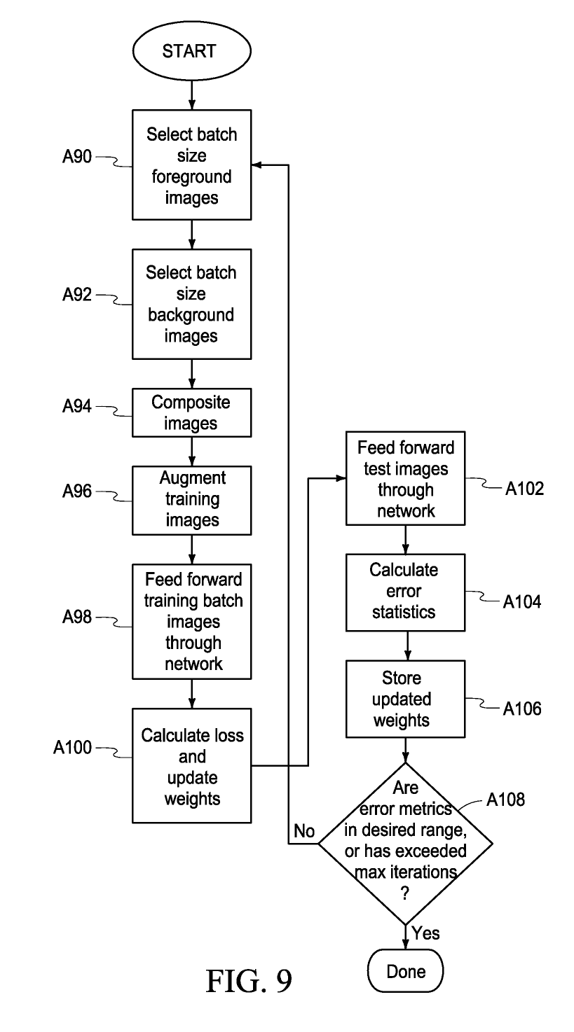

At an act A21, the selected network is trained using the training images for object classification and/or data generation for augmented content (e.g., calculation of desired AR estimands for object pose, lighting and state). The training images may be generated by compositing background and foreground images and performing augmentation as mentioned above. Additional details regarding training a network to classify objects and/or calculate AR estimands (e.g., location of object relative to the camera, orientation of the object relative to the camera, state of the object, lighting of the object) using a plurality of training images are described below with respect to FIG. 9.

As mentioned above, the GoogLeNet network is one example of a classification network which is capable of classifying up to 1000 different objects from a set of images. The GoogLeNet network may also be used as an augmented content network for generating the AR estimands described above by removing the softmax output layer, appending a fully connected layer of 2000 neurons in their place, and then adding seven outputs for object or camera pose. The weights from a previously trained GoogLeNet network may be reused as a starting point for common neurons and new weights (e.g., default) may be selected for new neurons, and the previous and new weights of the network may be adjusted during training methods described below in one embodiment. The process of retraining part of the network is known as transfer learning in the literature. It can greatly speed up the computational time needed to train a network for the augmented content estimands.

Referring to FIG. 4, one embodiment of a deep neural network which performs both classification of whether a real world object is present and calculation of AR data, such as estimands for position, rotation, lighting type, lighting position/direction and object state based on a GoogLeNet network is shown. The illustrated network outputs the following estimated values: position, rotation, the lighting position, lighting type, the state of the object and whether it is present in the input image. This example embodiment also shows optional input camera parameters near the top of the network. The optional camera parameter inputs may help in finding estimands that are consistent with the camera parameters (field of view, depth of field, etc.) of the camera that captured the input camera image. In the example illustrated embodiment, the layers after the final inception module have been added on to calculate the desired values. These new layers have replaced the final four layers in the GoogleLeNet network. In particular, the layers for classification have been replaced with layers designed to do regression to generate the estimands which are used to generate the augmented content.

Another embodiment of a neural network designed to assist in finding the pose of an object is a network that was previously trained to find keypoints on an object. Using a neural network, the location of the keypoints on an object can be found in image space as discussed in Pavlakos, Georgios, Xiaowei Zhou, Aaron Chan, Konstantinos G. Derpanis, and Kostas Daniilidis, “6-DoF Object Pose from Semantic Keypoints,” 2017, and http://arxiv.org/abs/1703.04670, the teachings of which are incorporated herein by reference. Using these keypoints and the parameters of the camera, one can solve for the position and orientation of the physical object using known techniques as discussed in the Pavlakos reference. These types of networks can also be modified to estimate lighting information and object state, and benefit from the training methods described below.

Referring to FIG. 5, a method of collecting background images and reflection maps according to one embodiment is shown. Other methods are possible including more, less and/or alternative acts.

At an act A22, it is determined whether a sufficient number of training images are present. For example, in some embodiments, approximately 25,000-100,000 training image are accessed for training operations.

If an insufficient number of training images are present, then additional images are collected and/or generated at an act A23. Additional images may include additional digital images of the real world object of interest or renders of the real world object of interest.

At an act A24, it is determined whether a sufficient number of reflection maps are present. In one embodiment, more than one and less than ten reflection maps are utilized.

If an insufficient number of reflection maps are present, then additional reflection maps are collected at an act A26.

At an act A27, it is determined whether computer generated reflection map(s) are desired. If yes, the process proceeds to an act A28 where additional reflection map(s) are generated, for example by 3D modelling. If no, the process of FIG. 5 terminates.

Referring to FIG. 6, a method of generating foreground images of a real world object by generating renders from a CAD or 3D model according to one embodiment is shown. Other methods are possible including more, less and/or alternative acts.

Before training of the network is started, the user sets the viewing and environmental parameters for which the network is expected to work. These parameters can be positional values like how close or far the object can be from the camera and orientation values of the object, i.e. the range of roll, pitch, and yaw an object can experience. An example of an orientation range would occur if one was only expected to see the front half of an object, then in this example yaw could be constrained to be between −90 and 90 degrees, pitch could be constrained to +/−45, and roll could be left unconstrained with values varying between −180 and 180.

Since camera orientation is relative to an object's frame of reference, some of these values are correlated to the viewing parameters. If training images are being created by rendering for example as discussed below, values within these given ranges may be selected. In some embodiments, the values are randomly selected to prevent unwanted biases in the training set which could occur from sampling values on a grid.

Referring to an act A30, one of a plurality of positions of the camera relative to the object is generated in camera space from the viewing and environmental parameters discussed above.

Referring to an act A32, one of a plurality of rotations of the camera relative to the object is generated in camera space from the viewing and environmental parameters discussed above.

At act A34, it is determined if the object would be visible in an image as result of the selections of acts A30 and A32. If not, the process returns to act A30.

If the object would be visible, the process proceeds to an act A36 where one of a plurality of states in which the object to be depicted is selected. In particular, if an object is expected to be seen in multiple states (e.g., changes in switch and knob positions, wear and tear, color, dirt and oil accumulation, etc.), the state of the object may be selected each time it is rendered, for example randomly.

In one embodiment, parameters related to lighting of the object may also be selected.

For example, at an act A38, a number of lights which illuminate the object in a rendering is selected.

At an act A40, it is determined whether all lights have been initialized where each light has been given a position, orientation, intensity and color in one embodiment.

If so, the process proceeds to an act A50 discussed in further detail below. If not, the process proceeds to an act A42 where the type of light is randomly selected (point, directional, spot, etc.).

At an act A44, the position of the light is selected.

At an act A46, the orientation of the light is selected.

At an act A48, the light intensity and color of the light is selected.

Following the initialization of all lights, the process proceeds to an act A50 where it is determined whether a reflection map will be utilized. If not, the process proceeds to an act A54. If so, the process proceeds to an act A52 to select a reflection map.

The above selections may be random in one embodiment.

At an act A54, the object is rendered to an output image with an alpha channel for compositing in one embodiment. The alpha channel specifies the transparency of the foreground image relative to the background image. Rendering can be done via many techniques and include but are not limited to rasterization, ray casting, and ray tracing.

Once rendering is complete for the generated image, the values of the different parameters described above are stored at an act A56.

Other values that are calculated may be stored as well. At an act A58, an axis-aligned bounding box of the object in the image space is stored.

At an act A60, it is determined whether the object has key points.

If not, the process terminates. If so, the process proceeds to an act A62 to calculate and store the location of the object's keypoints in image space in the output image. The stored values are associated with the output image and which may be used to train the networks to predict similar values given new images or test training of the network in one embodiment.

The test and training images are generated using the background images and the foreground images in one embodiment. The foreground and background images are composited where the real world object is superimposed upon one of the background images to form a training or test image. In other embodiments, only foreground images of the object are used as training or test images.

Referring to FIG. 7, an example method which may be used for augmenting test images and/or training images is shown according to one embodiment. For example, following the compositing of background and foreground images to form the images, there still may be insufficient data regarding the object to appropriately train a network for complicated tasks, such as pose detection. One embodiment for generating additional training data is described below.

Computer generated graphics may be used to augment the training data in some embodiments. Computer generated imagery has a tendency to not look quite natural, and without additional manipulation it does not represent the myriad of ways an object could appear when viewed from a wide range of digital cameras, environments and user actions. An augmentation pipeline described below may be used to simulate realism to assist networks with identifying real world objects and/or calculating estimands which may be used to generate augmented content associated with an object. The described acts of the example augmentation pipeline add extra unique data to images which are used to train (or test) networks. Other methods are possible including more, less and/or alternative acts.

At an act A70, blur is applied to a training image. Natural images can have multiple sources of blur. Blur can occur for many reasons and a few will be listed: parts of the scene can be out of focus, the camera or object can be moving relative to each other, and/or a dirty lens. Naively generated images will have no blur and will not work as well when detecting and tracking objects. Blurring can be done in multiple ways. In one example, an average blurring is used which takes the average pixel intensity surrounding a point and then assigns that value to the blurred images corresponding point.

In a second example, a gaussian blur is used which is essentially a weighted average of the neighboring pixels where the weight is assigned based on the distance from the pixel, a supplied standard deviation and the gaussian distribution.

$$G ( x , y ) = \frac{1}{2 {πσ}^{2}} {e}^{- \frac{{x}^{2} + {y}^{2}}{2 {σ}^{2}}} \qquad EQUATION 1$$

In one embodiment, a sigma value is selected in a supplied range of 0.6 to 1.6. Using this technique has been observed to increase a rate of detection by a factor of approximately 100, and greatly improved overall tracking of an object with a variety of cameras and environments. Other methods may be used for blurring images in other embodiments.

At an act A72, the chrominance of the image is shifted. Different cameras can capture the same scene and record different pixel values for the same location and capturing this variance in some embodiments may lead to improved network performance and assist with covering colored lighting situations. Shifting colors from 0% to 10% accommodates most arrangements using digital cameras in many indoor and outdoor settings.

At an act A74, the image's intensity is adjusted. The overall intensity in an image is a function of both the scene and many camera variables. To simulate many cameras and situations, the image's overall brightness may be increased and decreased. In one embodiment, a value between 0.8 and 1.25 may be randomly selected and used to change the intensity of the image.

At an act A76, the contrast of an image is adjusted. Once again, different cameras and camera settings can result in images with different color and intensity distributions. In one embodiment, contrast in the images is adjusted or varied to simulate the different distributions.

At an Act A78, noise is added to the images. Images captured in the real world generally have noise and noise is generally a function of the camera capturing the image, and can be varied based on the camera. In some embodiments, camera noise is gaussian noise where the values added to the signal are Gaussian distributed. A gaussian distribution with a mean of “a” and a standard distribution of “sigma” is provided in the following equation:

$${f}_{g} ( X ) = \frac{1}{\sqrt{2 {πσ}^{2}}} {e}^{\frac{- {( x - a )}^{2}}{2 {σ}^{2}}} \qquad EQUATION 2$$

The values of one or more of the above-identified acts may be randomly generated in one embodiment. The images resulting from FIG. 7 may include training images which are utilized to train a network to detect, track and classify real world objects as well as test images which are used to evaluate the training of the network in one embodiment.

Another embodiment could use a trained artificial neural network to improve the realism of generated imagery, an example of which would be using an approach similar to SimGAN which is described in Shrivastava, Ashish, et al. “Learning from simulated and unsupervised images through adversarial training.” arXiv preprint arXiv:1612.07828 (2016), the teachings of which are incorporated herein by reference.

As mentioned above, the neural network may be initialized. One example embodiment of initializing the network is described below with respect to FIG. 8. Other methods are possible including more, less and/or alternative acts.

At an act A80, it is determined whether transfer learning is to be utilized or not. In particular, a network trained to perform one task can be modified to perform another via transfer learning. Candidate tasks for transfer learning can be as simple as training a different set of objects, and complex as modifying a classifier to predict pose. Use of transfer learning can lead to reductions in training easily in the range of 100s of times.

If transfer learning is not used, the process proceeds to an act A86 to initialize weights of the connections of the new network. Initializing new weights is the process of assigning default values to connections of the network.

If transfer learning is to be used, the previously discovered weights of a first network may be used as a starting point for training a second network. At an act A82, the previous weights of the first network are loaded.

At an act A84, the weights of connections of the network that are not common to the two tasks are removed. In addition, new connections for the new task(s) (e.g., prediction of pose, lighting information, and state of an object) are added. In one example, fully connected layers are added to the network for predicting poses of an object, lights and state.

At an act A86, default values are assigned to any of the connections which were newly added to the network.

The training processes described below according to example embodiments of the disclosure teach a neural network to classify objects and/or to compute AR data (e.g., estimands for generation of augmented content described above) from a set of training images of the object. In one embodiment, the training images may be grayscale, color (e.g. RGB, YUV), color with depth (RGB-D), or some other kind of image of the object.

In one embodiment, each training image is labeled with the set of the corresponding estimands so the network can learn, by example, how to correctly predict the estimands on future images it has not seen. For example, if the goal is to train an object so that a network can estimate its pose then each of the training images is labeled with the correct pose. If the goal is to train the network to estimate the pose, physical state, and lighting environment of an object, then each training image is labeled with the corresponding pose, physical state, and lighting information. The images are labeled with the names of the objects if the goal is to train the network to classify objects.

In one embodiment, a loss function is used for training which compares the predicted estimand with the label of the actual values of each training image so the learning algorithm may compute how much to adjust the weights. In one embodiment, the loss function is

$$Loss = ‖ \hat{x} - x ‖ + α ‖ \hat{q} - \frac{q}{‖ q ‖} ‖ + β ‖ \hat{s} - s ‖ + γ ‖ \hat{l} - l ‖ + δ ‖ \hat{d} - \frac{d}{‖ d ‖} ‖ \qquad EQUATION 3$$

where the ̂ (hat) symbol over a variable represents the true labeled value of the training image, the variables without the hat symbol are those predicted by the network, x is the position vector component of the pose, q is the quaternion of the rotation component of the pose, s is the physical state vector, l is the lighting environment vector, and d is the quaternion of the angle of the light source relative to the object. The double vertical bars represent the Euclidean norm. If for a particular application one or more of the estimands are not needed, then they may be dropped from the network architecture and the loss function.

The scaling factors α, β, γ, and δ set the relative importance in fitting each of the terms. Some experimentation may be required to discover the optimal scale factors for any particular object or application. One method is to do a grid search for each scale factor individually to find the optimal values for the object or class of objects that are being trained. Each grid search will consist of varying one of the scale factors, then training the network and measuring the relative uncertainty of the estimands. The goal is to reduce the total error of all estimands. Different network architectures or sets of estimands may require different values for optimal predictions. The scale factors may be determined using other methods in other embodiments.

If the network also takes as input the camera parameters such as focal length and field of view, then these parameters may need to be varied over a reasonable range of values that are expected in the application camera that will use the network. These values also accompany the training images.

If the network is recurrent which means it has cycles in its graph, then the training described below may be adjusted so that a chronological sequence of image frames are trained with the network so it can learn to use memory of the previous frames to predict estimands in the current frame. In one embodiment, the training data may be generated by modeling or capturing continuously varying parameters such as pose, lighting configuration, and object state.

Different training scenarios are described below in illustrative embodiments. In each case, some of the training images are used as test and validation images to measure the progress of training and to tune hyperparameters of the network and such test images are not used to train the network.

When a three-dimensional digital model of an object exists, it can be used to generate an unlimited amount of training images for the network by generating two-dimensional renders of the object. In addition, a model of the object may include metadata corresponding to the object, such as tags indicative of a part number, manufacturer, serial number, etc. with respect to the object. Once an object is detected in a camera image from display device 10, metadata from the model for the object may be extracted from a database and communicated to the display device 10. The display device 10 may use the metadata in different ways, for example, generating augmented content including the metadata which is displayed to the user.

In one embodiment, a set of reflection maps may be prepared ahead of time and used during the rendering operations for simulating reflections on the object. This may be especially important for objects that have highly polished or reflective surfaces. Varying the reflection maps in the renders is useful in some arrangements so the network does not learn features or patterns caused by extrinsic factors. Also, a set of background images may be prepared to place behind the rendered object. Varying the background images may be utilized to help the network not learn features or a pattern in the background instead of the object of interest. For each training image, a random camera or object pose, reflection map, lighting environment, physical state of the object and background image are selected and then used to render the object as an image while recording the corresponding estimands for the image. The result is a set of images of the object without the manual labor of collecting photographs of the object. In other embodiments, photographs of an object are used alone or in combination with renders of the object and the estimands for the respective photographs are also stored for use in training. These training images and the corresponding estimands are used to train the network.

With an unlimited number of possible training images, it is feasible to train an entire deep neural network from scratch. It is also possible to retrain an existing network for different objects, for example, using transfer learning. It may be the case that a network has been trained on one object, then a new network is retained for another object with fewer training images. Retraining entails using some of the weights from a previously trained network, typically those nearest to the input which describe low-level features, while re-initializing the final layer or layers and performing backpropagation to adjust all weights using a new set of training images. In one embodiment, a pretrained convolutional neural network (CNN) that is used for image classification can be repurposed by reusing the weights from the convolutional layers which extract features from the image, then retraining the final fully connected layers to learn the estimands.

If the network will be designed to predict the presence of the object, then it may be important to train it with images that do not contain the object. This can be accomplished by passing in the random background images mentioned above. The loss function for these training images may be modified to ignore the other estimands since they are not relevant when the object is not present.

The object may be present in environments which cause it to accumulate dirt, grease, scratches or other imperfections. In one embodiment, the training images may be generated with simulated dirt, grease, and scratches so that the network learns to correctly predict the estimands even when the object is not in pristine condition.

Referring to FIG. 8, a method for training a network to calculate estimands which may be used to generate augmented content is shown. A computer system performs the method in one implementation. Other methods are possible including more, less and/or alternative acts.

In this example, a large collection of foreground images of the object of interest for training are rendered, for example, as discussed in one embodiment with respect to FIG. 9. The object may be placed in various poses and the location and orientation of the object relative to the camera is known. Reflection maps are used to modify the foreground images and the foreground images are composited with background images to generate training images in one embodiment. The backgrounds and reflection maps are used to provide variations that will allow the network to learn only the intrinsic features of the object of the foreground images and not fit to the extrinsic factors of variation. Instead of or in addition to use of renders of the object, a plurality of different photographs under different conditions and from different poses may be used.

The described example training method utilizes batch training which implements training using a batch (subset) of the training images.

Initially, at an act A90, a batch of foreground images are randomly selected in one embodiment.

At an act A92, a batch of background images are randomly selected in one embodiment.

At an act A94, the selected background and foreground images are composited, for example as described above.

At an act A96, the composited images are augmented, for example as described above.

At an act A98, the batch training images are applied to the neural network to be trained in a feed forward process which generates estimands for example, of object pose, lighting, and state.

At an act A100, the stored values corresponding to the estimands for the training images are accessed and a loss is calculated which is indicative of a difference of the estimands calculated by the network and the stored values. In one example, equation 3 described above is used to calculate the loss which is used to adjust the weights of the neural network in an attempt to reduce the loss. In one embodiment, the loss is used to update the network weights via stochastic gradient descent and back propagation. Additional details regarding back propagation are discussed in pages 197-217, section 6.5 and additional details regarding stochastic gradient descent are discussed in pages 286-288, section 8.3.1 of Goodfellow, et. al., Deep Learning, MIT Press, 2016, www.deeplearningbook.org, the teachings of which are incorporated by reference herein.

At an act A102, the set of test images is fed forward through the network with the adjusted weights and the estimands for poses, states and lighting conditions.

At an act A104, error statistics are calculated as differences between the estimands and the corresponding stored values for the test images.

At an act A106, the updated weights of the connections are stored.

At an act A108, it is determined if the error metrics from act A104 are within desired range or whether a maximum number of iterations have been exceeded. In one example, an error metric may be within a desired range by comparing the performance of calculated estimands to a desired metric, an example being +/−1 mm in position of the object relative to camera. This act can also check for overfitting to the training data, and terminate the process if it has run for an extended period without meeting the desired metrics.

If the result of act A108 is affirmative, the network is considered to be sufficiently trained and the neural network including the weights stored in act A106 may be utilized to evaluate additional images for classification and/or generation of AR data.

If the result of act A108 is negative, the network is not considered to be sufficiently trained and the method proceeds to act A90 to begin training with a subsequent new batch of training images on demand.

In one embodiment, the size of the training set may be selected during execution of the method and training images may be generated on demand to provide a sufficient number of images. In addition, foreground images and training images may also be generated on demand for one or more of the batches.

Another example training procedure is provided for techniques based on keypoint neural networks which output the subjective probability of a keypoint of the object being at a particular pixel. The loss back propagated through the network is the difference between the estimated probability and the expected probability. The expected probability is a function of the keypoint positions in image space stored during foreground image generation. Additional details are described in the Pavlakos reference which was incorporated by reference above. A point is assumed to be at the pixel with the highest probability and these discovered points are mapped to the keypoints on the model. In one implementation, Efficient PnP and RANSAC are used to predict to the position of the object in camera space and error statistics are calculated based on predicted pose and lighting conditions and updated weights are stored. Training via a plurality of batches of training images is utilized in one embodiment until error metrics are within a desired range.

In some cases, it may not be feasible to construct a digital model of the object and photographs may be captured of the real physical object to generate test and training images in another embodiment. In order to efficiently label each photo with the correct value of the pose estimand, a fiducial marker may be placed next to the object so that traditional computer vision techniques can compute the camera pose relative to the fiducial marker for each foreground image. An example of a computer vision technique that could be used to find the pose is Efficient PnP. In another embodiment, a simultaneous location and mapping (SLAM) algorithm may be applied to a video sequence that records a camera moving around the object. The SLAM algorithm provides pose information for some or all of the frames. Both of the above-described techniques may be combined in some embodiments. Another embodiment could use a commercial motion capture system to track the position of the camera, and object throughout the generation of training images.

The lighting parameters of the photographs are computed and recorded for each of the foreground images. The lighting environment may be fixed over the set of the photos or varied by either waiting for the lighting environment to change or manually changing the lights. One example way the lighting direction may be recorded is by placing a sphere next to the object and analyzing the light gradients on the sphere. Additional details are discussed in Dosselmann Richard, and Xue Dong Yang, “Improved Method of Finding the Illuminant Direction of a Sphere,” Journal of Electronic Imaging, 2013. If the object is outside, then the lighting configurations may be estimated by computing the position of the sun while considering the weather or shadowing from other objects. This may be combined with the sphere technique mentioned above in some embodiments.

If the object is to be seen in many scenes and situations, background subtraction may be performed upon the input frames, and the resultant image of the object may be composited over random backgrounds similar to the process described above for 3D renders of the object. In one embodiment, background subtraction can be implemented by recording the object in front of a green screen and performing chroma key compositing to remove the background.

If the network is designed to predict the presence of the object, then the network is trained with images that do not contain the object in some embodiments. This can be accomplished by passing in the random background images mentioned above without an image of the object. The loss function for these training images may be modified to ignore the other estimands since they are not relevant when the object is not present.

Photographs of the object may be used to train a network to identify where an object is in frames of a video in one embodiment. It is a similar process to the embodiments discussed above with respect to training using renders of the object, but instead of generating the pose of a 3D model of the object, the pose is computed separately in each image or video frame, for example using a fiducial marker placed by the object. In one embodiment, the camera is positioned in different positions relative to the object during capture of photographs of all or part of the object and estimands are calculated for pose, lighting and state and stored with the photographs. Lighting parameters may be computed and recorded for the object in each of the photographs, such as gathering position of the ambient lights, material properties of the object, etc. These parameters may be used to successfully deduce the lighting during augmentation of the images. The foreground images (i.e., photograph of the object in this example) may be composited with random backgrounds discussed above and augmented, and thereafter the resultant augmented images may be used to test and train the network using the stored information regarding the object in the respective images, such as pose, lighting and state. In some embodiments, different batches of training images including photographs of the object may be used in different training iterations of the network, and additional training images may be generated on demand in some implementations.

If a digital model is not available, and it is not feasible to compute the pose of an object in photographs, then the photographs of the object may be combined using photogrammetry/structure from motion (SfM) to create a digital model. Once a digital model is constructed, the material properties may be described so that the renders can model the physical properties of the object.

The values corresponding to the estimands to be computed are stored in association with the training images (photographs) for subsequent use during training. These training images and stored values can be used by the example training procedures discussed above with respect to renders of a CAD or 3D model of the object.

For some applications, it may be desired to train a network to detect an object and calculate the pose for any object within a class that have similar appearance but with slight variations. Training a class of objects may be performed with renders or with photographs as described above. For the former, the variations of the class should be understood and modeled as best as possible so that the network learns to generalize to the object class. For the latter, photographs may be taken of a representative sample of the different variations.

If it is desired to compute the pose estimands for more than one object, a separate neural network classifier may be trained so that objects in input images can be properly classified in one embodiment. Thereafter, one of a plurality of different augmented content networks is selected according to the classification of the object for computing the AR estimands. Numerous training images may be used for training classifier networks. However, fewer images may be used if an existing classification network is retrained for this purpose through the process of transfer learning described above. The same images used for training the AR estimands above may be used to train the classification network. However, the stored labels of the training images for the classification network consist of the identifier for the object.

It may also be beneficial for the augmented content networks for multiple objects of a class to share part of their networks. In one embodiment, the initial layers may be shared and only the final layers are retrained to provide AR estimands for each object. This may be more efficient when multiple objects need to be tracked.

In one embodiment, the object may be a landscape or large structure for which the application camera cannot capture the entire object in one image or video frame. However, the described training process may still apply to these types of objects and applications. In one embodiment, it may be possible to capture the data quickly with wide-angle cameras or even a collection of cameras while recording location from GPS and computing camera directions from a compass. If photographs of the object are captured with wide-angle or 360 photography (e.g., stitching of still images or video frames), then the training image may be cropped from the large image to reflect the properties of the application camera of the display device 10 in one embodiment.

Once a network has been trained to classify an object and/or generate AR data for an object, it can be deployed as part of an application to client machines for computing the estimands for a given image or video frame. The discussion now proceeds with respect to aspects of applying the network for use to generate augmented content, for example, with respect to a real world object.

The network is capable of tracking an object via detection by re-computing the pose from scratch in every frame in one embodiment. In another embodiment, the detection and tracking are divided into two separate processes for better accuracy and computational efficiency. In another embodiment, tracking may be more efficient by creating and training a recurrent neural network that outputs the desired estimands.

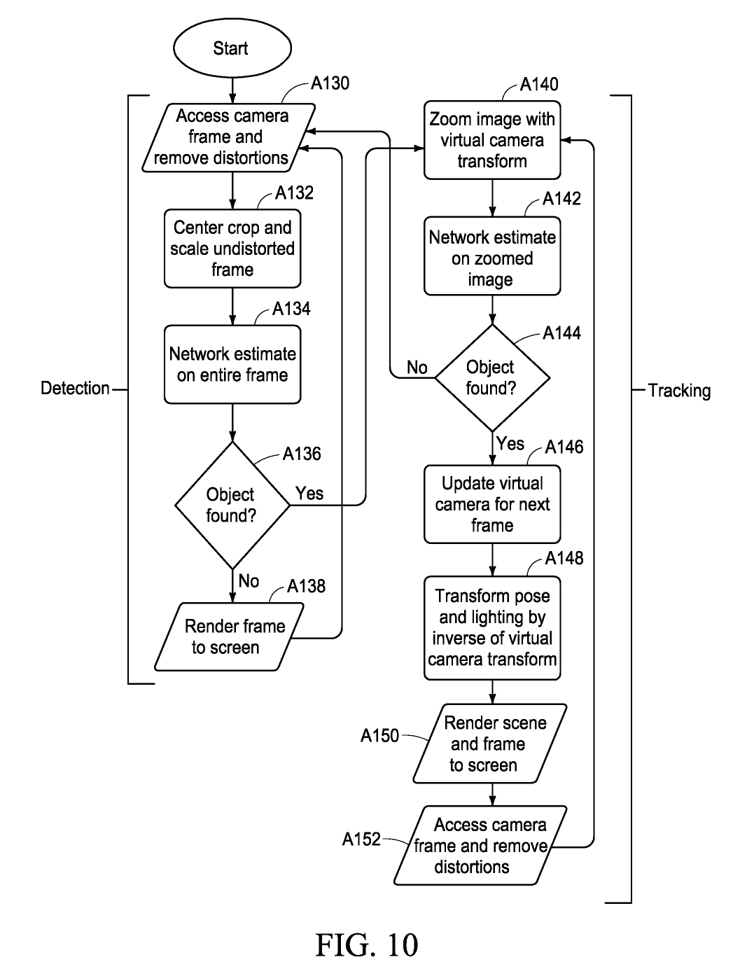

Referring to FIG. 10, a method of detecting and tracking a real world object in images, such as photographs or video frames generated by a display device, is shown according to one embodiment. The display device can generate augmented content which may be displayed relative to the object in video frames which are displayed by the display device to a user in one embodiment. The method may be executed by the display device, or other computer system, such as a remote server in some embodiments. Acts A130-A138 implement object detection while acts A140-A152 implement object tracking in the example method. Other methods are possible including more, less and/or alternative acts.

At an act A130, a camera image, such as a still photograph or video frame, generated by a display device or other device is accessed.

The camera optics which generated the frame may create distortions (e.g. radial and tangential optical aberrations) that deviate from an ideal parallel-axis optical lens. In one embodiment, the application camera may be calibrated with one or more photos of a calibration target, for example as discussed in Zhang Zhengdong, Matsushita Yasuyuki, and Ma Yi, “Camera Calibration with Lens Distortion from Low-Rank Textures,” In CVPR, 2011, the teachings of which are incorporated herein by reference. The intrinsic camera parameters may be measured during the calibration procedure. The measured distortions are used to produce an undistorted camera image in some embodiments so the augmented content may be properly aligned within the image since the augmented content is typically rendered with an ideal camera. Otherwise, if the raw distorted image is shown to the user, the augmented content may be misaligned.

In one embodiment, the mapping to remove distortions may be pre-computed for a grid of points covering the image. The points map image pixels to where they should appear after the distortions are removed. This may be efficiently implemented on a GPU with a mesh model where vertices are positions by the grid of points. The UV coordinates of the mesh then map the pixels from the input image to the undistorted image coordinates. This process may be performed on every frame before it is sent to the neural network for processing in one embodiment. Hereafter, we assume the processing will be performed on the undistorted camera image according to some embodiments and it may be referred to as simply the camera image.

At an act A132, the camera image may be cropped and scaled to match the expected aspect ratio of input images to the network to be processed. For example, if the camera image is 1024×768 pixels and the network instance expects an image having 224×224 pixels, then first crop the center of the camera image (e.g., 768×768 pixels) and scale the camera image by a factor of 224/768. The camera image is now the correct dimensions to feedforward through the network. Other methods may be used to modify the camera image to fit the dimensions of the input layer of the network.

At an act A134, the neural network estimates the AR estimands, for example for pose, lighting, state and presence of the object.

At an act A136, it is determined whether the object was found in the camera image. In one embodiment, the uncertainty of the estimands may be estimated. If the uncertainty estimation is larger than a threshold, then the AR overlay is disabled until a better estimate of the estimands can be obtained on the object in one embodiment. A network may have an output to estimate the presence of the object, but the object might be partially obscured or too far away for an accurate estimate.

One technique that may be used to model the uncertainty is Bernoulli approximate variational inference in one embodiment. With this process, an image is feed through the network multiple times with some neuron connections randomly dropped. The variance of the distribution of estimands from these trials may be used to estimate the uncertainties of the estimands as discussed in Konishi Takuya, Kubo Takatomi, Watanabe Kazuho, and Ikeda Kazushi, “Variational Bayesian Inference Algorithms for Infinite Relational Model of Network Data,” IEEE Transactions on Neural Networks and Learning Systems, 26 (9), pages 2176-81 2015, the teachings of which are incorporated herein by reference.

If the result of act A136 is negative, the process proceeds to an act A138 to render the camera image to a display screen, for example of the display device, without generation of AR content.

If the result of act A136 is affirmative, the process proceeds to an act A140 where the estimands are refined. In one embodiment, a zoom image operation is performed using a virtual camera transform to refine the estimands in one embodiment. More specifically, if the object takes up a small portion of the camera image, then the network may not be able to provide accurate estimates because the object may be too pixelated after downscaling of the entire image frame. An improved estimate may be found by using the larger camera image to digitally zoom toward the object to obtain a subset of pixels of the camera image which includes pixels of at least a portion of the object and additional pixels adjacent to the pixels of the object. In this described embodiment, instead of scaling the entire image, a subset of the image is used to provide a higher resolution image of the object.

In another embodiment, a bounding box of the object in the image may be identified and used to select the subset of pixels. One method to determine the location of the object in the camera image is to use a region convolutional neural network (R-CNN) discussed in Girshick Ross, Donahue Jeff, Darrell Trevor, and Malik Jitendra, “Region-Based Convolutional Networks for Accurate Object Detection and Segmentation,” IEEE Transactions on Pattern Analysis and Machine Intelligence, 2016, 38 (1), pages 142-58, the teachings of which are incorporated by reference herein. The R-CNN has been previously trained on the objects of interest to localize a bounding box around the object. Another method to determine the location of the object in the camera image is to use the pose estimate from the full camera image to locate the object in the image.

Following the location of object, the camera can be effectively zoomed into the region of interest that contains the object. The object may be cropped from the larger image by determining the size and center of the object as it appears in the image in one embodiment. Modifying the camera image by zooming in to the object within the camera image may yield a better estimate of the estimands of the object.

Consider a virtual camera that shares the same center of convergence as the camera that captured the image (e.g., image camera of display device 10). In one embodiment, the virtual camera is rotated and the focal length is adjusted to look at and zoom in on the object of interest and a transformation between the image camera and virtual camera is applied to the camera image to produce the zoomed image. The rotation matrix R to transform the image camera into the virtual camera is found by computing a rotation and axis of rotation which results in a rotation matrix,

$$R = cos θ I + sin {θ [ u ]}_{\times } + ( 1 - cos θ ) u ⊗ u , \\ u = \frac{\vec{c} \times \vec{v}}{‖ \vec{c} \times \vec{v} ‖} , \\ u ⊗ u = [ \begin{matrix}{u}_{x}^{2} & {u}_{x} {u}_{y} & {u}_{x} {u}_{z} \\ {u}_{x} {u}_{y} & {u}_{y}^{2} & {u}_{y} {u}_{z} \\ {u}_{x} {u}_{z} & {u}_{y} {u}_{z} & {u}_{z}^{2}\end{matrix} ] , \\ {[ u ]}_{\times } = [ \begin{matrix}0 & - {u}_{z} & {u}_{y} \\ {u}_{z} & 0 & - {u}_{x} \\ - {u}_{y} & {u}_{z} & 0\end{matrix} ] , \\ \vec{c} = ( 0 , 0 , f ) , \\ \vec{v} = ( i , j , \sqrt{{i}^{2} + {j}^{2} + {f}^{2}} ) , \\ θ = {cos}^{- 1} ( \vec{c} \cdot \vec{v} )$$

where \vec{c} is the a vector from the camera center to the image plane, \vec{v} is a vector from the camera center to the center of the crop region (i,y), f is the focal length of the image camera. The vector \vec{u} is the axis of rotation and θ is the magnitude of the rotation.

When the original camera image is transformed, the pose estimate from the network will predict a camera distance that may not match the digital rendering corresponding to the entire camera image. For proper alignment with Augmented content, the estimated pose distance may need to be scaled by

S_{C}=min(w_{I}/w_{C},h_{I}/h_{C})

where w_{I} and h_{I} are the camera image width and height, w_{C} and h_{C} are the effective crop width and height that is desired. The focal length for the virtual camera is

fᵥ=S_{C}f

The computer system may transform between the camera image and zoom image using the above rotation matrix and focal length adjustment in one embodiment. The projection matrix, also referred to as a virtual camera transform, to transform the camera image into the zoomed image is,

$$P = {K}_{v} {RK}^{- 1}$$

$${K}_{v} = [ \begin{matrix}{f}_{v} & 0 & {p}_{x} \\ 0 & {f}_{v} & {p}_{y} \\ 0 & 0 & 1\end{matrix} ]$$

where Kᵥ is the camera calibration matrix for the virtual camera, pₓ and p_{y} are the coordinates of the principal point that represent the center of the virtual (i.e., zoomed) image, and K is the camera calibration matrix for the image camera which is measured in the camera calibration procedure mentioned above.

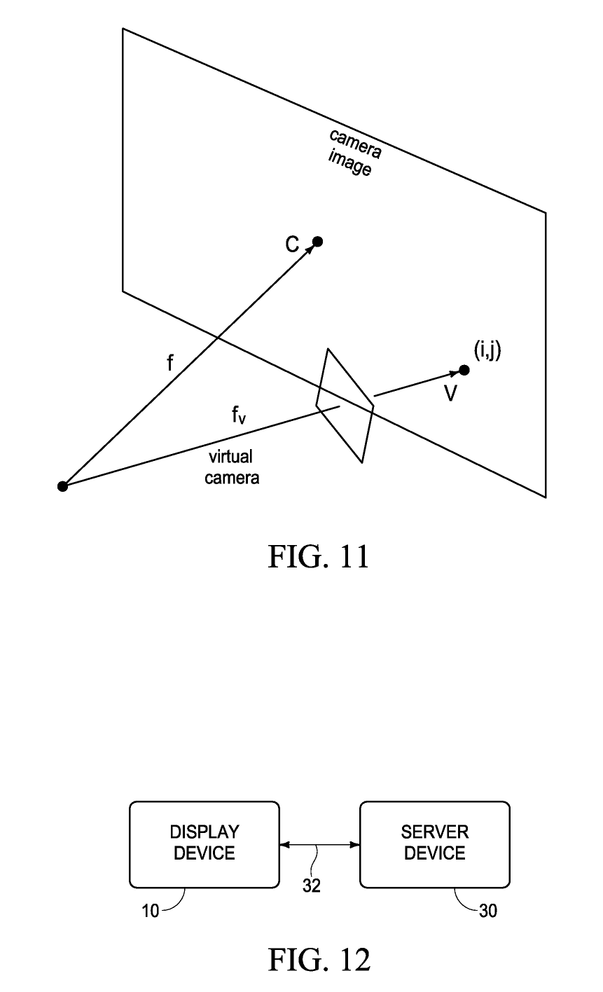

Referring to FIG. 11, an example geometry of the image camera and the virtual camera used to crop the object from the camera image (i.e. digitally zoom into the camera image) for processing are shown. While this transformation effectively creates a zoomed image of the camera image, it is not technically a regular crop of the camera image since the image plane is being reprojected to a non-parallel plane as shown in FIG. 11 to minimize distortions that arise off-axis in a rectilinear projection. The transformation between the image camera and virtual camera is saved for post-processing described below.

Referring again to FIG. 10, the zoomed image, which is a higher resolution image of the object compared with the object in the camera image, is evaluated using a neural network to generate a plurality of estimands for one or more of object pose, lighting pose, object presence and object state which are useable to generate augmented content regarding the object according to one embodiment. The zoomed image is evaluated by the network using a feed forward process through the network to generate the estimands at an act A142. The use of the higher resolution image of the object provides an improved estimate of the estimands compared with use of the camera image.

At an act A144, it is determined whether the object has been located within the zoomed image. For example, the uncertainty estimate discussed with respect to act A136 may be utilized determine whether the object is found in one embodiment.

If the object has not been found, the process returns to act A130. If the object has been found, the process proceeds to an act A146 where the location and orientation of the virtual camera with respect to the object is stored for subsequent executions of the tracking process.

At an act A148, an inverse of the virtual camera transform is applied to the pose estimate from the network from Act A142 to obtain proper alignment for display of the augmented content in the original camera image depending on if the object pose or camera pose is being estimated. For example, in an embodiment where zooming was used to refine the AR estimands as described above, the pose estimands may need to be converted back into a camera coordinate frame consistent with the entire image instead of a coordinate frame of the virtual camera which generated the zoomed image. This act may be utilized for proper AR alignment where the augmented content is rendered in the camera coordinate system that considers the entire camera image.

In one embodiment, if the network is used to estimate the camera pose (in object coordinates), then the camera pose rotation can be adjusted by the inverse of the rotation matrix, R, computed above. The camera pose distance is scaled by 1/S_{C}. If the image camera (e.g., of the display device 10) has a different focal length than the camera used to generate training images of the network, then an additional scaling of f/fₜ may be used where f is the focal length of the image camera, and fₜ is the focal length of the camera used to generated the training images. After the estimated pose is scaled and rotated, the augmented content may be rendered over the camera image to be in alignment with the real world object in the rendered frame.

In another embodiment, If the network is used to estimate the object pose (in camera coordinates), then the pose may be inverted and adjusted as described above before inverting back to camera coordinates. The object pose may be a better estimate than the camera pose, since the position and rotation components will be less coupled in camera coordinates. For example, if an object is rotated about the center of object coordinates, then only the object pose rotational component is affected. However, both the rotational and positional camera pose components are affected with the equivalent rotation of the object.

At an act A150, the scene including the augmented content (e.g., virtual object, text, etc.) and frame including the camera image are rendered to a display screen, for example of a display device, projected or otherwise conveyed to a user.

At an act A152, another camera image (e.g., video frame) is accessed and distortions therein may be removed as discussed above with respect to act A130 and the process returns to act A140 for processing of the other camera image using the same subset of pixels corresponding to the already determined zoom image.

In some embodiments, tracking by detection may be used where the same feedforward process is used for every frame to compute the estimands. In other embodiments, it may be more efficient to have separate processes for detection and tracking of an object. The feedforward process described above is an example detection process. For tracking, it may not be needed to keep sending the full camera image if the object does not take up the full image. Under the reasonable assumption that the object image will move little or not at all from frame to frame, the next frame's zoom image can look were the object was found in the last frame. Even when the assumption is broken, the detection phase may rediscover the object if it is still visible. This may eliminate the repeated step of first searching for the object in the full frame before refining the estimands in a second pass through the network.

There may be different detection and tracking strategies depending on the goals of the application. In one application, only recognizing/detecting and tracking of a single object is used. Other applications may track multiple objects one at a time (e.g., in a sequence) or track multiple objects simultaneously in the same images.

For example, if one of a plurality of objects is detected and tracked at a time in a sequence, the computer system may run a classifier network to identify the objects present in the camera image. Thereafter, an appropriate augmented content network for the detected object may be loaded and used to calculate AR estimands for the located object in a manner similar to FIG. 10 discussed above. This may be repeated in a sequence for the remaining objects in the camera image.

In one embodiment, a R-CNN may be used to find a bounding box around an object. This may aid in creating the zoom region as described above instead of relying on pose from a network to determine the location.

If the application recognizes several objects simultaneously in the same camera view, then the image may be passed through multiple network instances corresponding to the respective objects for each frame. If the multiple networks share the same architecture and weights for part of the network, then it may be computationally more efficient to break the networks up into a shared part and a unique part. One reason multiple networks may share the same architecture and weights for part of the network is because they were retrained versions of the same pretrained network and therefore share some of the same weights. The shared part can process the image, then the outputs from the shared sub-network are sent to the unique sub-networks for each image to generate their estimands of the different objects. Different virtual cameras can be used for the respective objects to generate refined AR estimands for the respective objects as discussed above with respect to FIG. 10.

Given the determined augmented reality estimands, augmented content can be generated and displayed as follows in one example embodiment. A viewport is set up in software and in general this viewport is created in a way to simulate the physical camera that was the source of the input frame. The calculated augmented reality estimands are then used to place the augmented content relative to the viewport. For example, estimated lighting values of the estimands are used to place virtual lights in the augmented scene. The estimated position of the object (or camera) be used to place generated text and graphics in the augmented scene. If a state was estimated, this may be used to decide what information would be displayed and what state the graphics would be in, animation, texture, part configuration etc. in the augmented content. For example, if an object is estimated to be in or have a first state at one moment in time, then first augmented content may be displayed with respect to the object corresponding to the first state. If the object is estimated to be in or have a second state at a second moment in time, then different, second augmented content may be displayed with respect to the object corresponding to the second state. Once the scene has been set up using the augmented reality estimands, the rendering proceeds using standard rasterization techniques to display the augmented content.

In some embodiments, the application of a network for classification, detection, and tracking as well as display of augmented content may be done entirely on a display device. However, the processing time may be too slow for some display devices.

Referring to FIG. 12, a system is shown including a display device 10 and server device 30. In this example, a camera of the display device 10 captures photographs or video frames and communicates them remotely to the server device 30 using appropriate communications 32, such as the Internet, wireless communications, etc. The server device 30 executes a neural network to evaluate the photographs or video frames to generate the AR estimands for an object and sends the estimands back to the display device for generation of the augmented content for display using the display device 10 with the photographs, video frames or otherwise. In some embodiments, the service device 30 may also use the estimands to generate the augmented content to be displayed and communicate the augmented content to the display device 10, for example as a 2D photograph or frame which includes the augmented content. The display device 10 displays the augmented content to the user, for example the display device 10 displays or projects the augmented content, such as graphical images and/or text as shown in the example of FIG. 1, with respect to the real world object.

In one embodiment, as networks are trained to classify, detect, track and generate AR estimands of objects and groups of objects, they may be stored in a database that is managed by server device 30 and may be made available to display devices 10 via the Internet, a wide area network, an intranet, or a local area network depending on the application requirements.

For example, the display device 10 may request sets of networks to load for classification of objects and generation of augmented content for different objects. These requests may be based on different contexts. In one embodiment, a user may have a work order for a specific machine and server device 30 may look up and retrieve the networks that are associated with objects relevant to the work order and communicate them or load them onto the display device 10.

In another embodiment, a user may be moving around a location. Objects may be associated with specific locations during the training pipeline. The display device 10 may output information or data regarding its location (e.g., GPS, Bluetooth low energy (BLE), or time of flight (TOF)) to server device 30 and retrieve networks from server device 30 for its locations and use, or cache the networks when in specific locations with the expectation that the object may be viewed in some embodiments.

As mentioned above, a display device 10 including a display 12 configured to generate graphical images for viewing may be used for viewing the augmented content, for example, overlaid upon video frames generated by the display device 10 in one embodiment. In another embodiment, the display device may be implemented as a projector which is either near or on the user of the application, and the digital content is projected onto or near the object of interest. The same basic principles apply that are discussed above. For example, if the projector has a fixed position and rotation offset from the camera of the display device 10, then this transformation may be applied to the pose estimate from the network for proper alignment of content. In yet another embodiment, a drone which has a camera and projector accompanies a user of the application. The camera of the drone is used to feed the networks to predict the estimands and the projector augments the object with augmented content based on requirements of the application in this example.

An application may specify detection, tracking, and AR augmenting for many objects. As mentioned above, in some embodiments, a unique network (and possibly a classification network) for each object or a group of objects may be utilized and it may not always be feasible to store all the networks on the display device 10 and such network(s) may be communicated to the display device 10 as needed.

A pipeline for training new objects and storing the networks on a server 30 for later retrieval by display devices 10 that track objects in real time may be used. An efficient pipeline for training networks for new objects may be used to scale to ubiquitous AR applications with the aim to reduce human interaction when training the networks.

In one embodiment, the pipelines take as input a digital CAD or 3D model of the object, for example, a CAD representation that was used for the manufacture of the object. Next, the random pose, lighting, and state configurations are chosen to generate random renders. Some of the renders are used for training, while others are saved for testing and validation. While the network is being trained, it is periodically tested against the test images. If the network performs poorly, then additional renders are generated. Once the network has been trained well enough to exceed some threshold, then the validation set is used to quantify the performance of the network. The final network is uploaded to a server device 30 for later retrieval.

If the object is needed for multiple object detection and tracking as described above, then the renders may be used to update an existing classification network or they may be used to train a new classification network that includes other objects in the training pipeline.

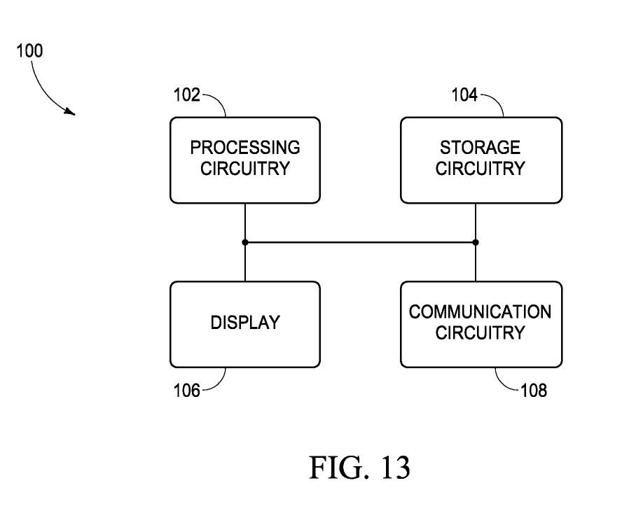

Referring to FIG. 13, one example embodiment of a computer system 100 is shown. The display device 10 and/or server device 100 may be implemented using the hardware of the illustrated computer system 100 in example embodiments. The depicted computer system 100 includes processing circuitry 102, storage circuitry 104, a display 106 and communication circuitry 108. Other configurations of computer system 100 are possible in other embodiments including more, less and/or alternative components.

In one embodiment, processing circuitry 102 is arranged to process data, control data access and storage, issue commands, and control other operations implemented by the computer system 100. In more specific examples, the processing circuitry 102 is configured to evaluate training images, test images, and camera images for training or generating estimands for augmented content. Processing circuitry 102 may generate training images including photographs and renders described above.

Processing circuitry 102 may comprise circuitry configured to implement desired programming provided by appropriate computer-readable storage media in at least one embodiment. For example, the processing circuitry 102 may be implemented as one or more processor(s) and/or other structure configured to execute executable instructions including, for example, software and/or firmware instructions. Other exemplary embodiments of processing circuitry 102 include hardware logic, PGA, FPGA, ASIC, and/or other structures alone or in combination with one or more processor(s).

Storage circuitry 104 is configured to store programming such as executable code or instructions (e.g., software and/or firmware), electronic data, databases, trained neural networks (e.g., connections and respective weights), or other digital information and may include computer-readable storage media. At least some embodiments or aspects described herein may be implemented using programming stored within one or more computer-readable storage medium of storage circuitry 104 and configured to control appropriate processing circuitry 102. Storage circuitry 104 may store one or more databases of photographs or renders used to train the networks as well as the classification and augmented content networks themselves.

The computer-readable storage medium may be embodied in one or more articles of manufacture which can contain, store, or maintain programming, data and/or digital information for use by or in connection with an instruction execution system including processing circuitry 102 in the exemplary embodiment. For example, exemplary computer-readable storage media may be non-transitory and include any one of physical media such as electronic, magnetic, optical, electromagnetic, infrared or semiconductor media. Some more specific examples of computer-readable storage media include, but are not limited to, a portable magnetic computer diskette, such as a floppy diskette, a zip disk, a hard drive, random access memory, read only memory, flash memory, cache memory, and/or other configurations capable of storing programming, data, or other digital information.

Display 106 is configured to interact with a user including conveying data to a user (e.g., displaying visual images of the real world augmented with augmented content for observation by the user). In addition, the display 106 may also be configured as a graphical user interface (GUI) configured to receive commands from a user in one embodiment. Display 106 may be configured differently in other embodiments. For example, in some arrangements, display 106 may be implemented as a projector configured to project augmented content with respect to one or more real world object.

Communications circuitry 108 is arranged to implement communications of computer system 100 with respect to external devices (not shown). For example, communications circuitry 108 may be arranged to communicate information bi-directionally with respect to computer system 100. In more specific examples, communications circuitry 108 may include wired circuitry (e.g., network interface card (NIC)), wireless circuitry (e.g., cellular, Bluetooth, WiFi, etc.), fiber optic, coaxial and/or any other suitable arrangement for implementing communications with respect to computer system 100. In more specific examples, communications circuitry 108 may communicate images, estimands, and augmented content, for example between display devices 10 and server device 30.

In more specific examples, computer system 100 may be implemented using an Intel x86-64 based processor backed with 16 GB of DDR5 RAM and a NVIDIA GeForce GTX 1080 GPU with 8 GB of GDDR5 memory on a Gigabyte X99 mainboard and running an Ubuntu 16.04.01 operating system. These examples of processing circuitry 102 are for illustration and other configurations are possible including the use of AMD or Intel Xeon CPUs, systems configured with considerably more RAM, AMD or other NVIDIA GPU architectures such as Tesla or a DGX-1, other mainboards from Asus or MSI, and most Linux or Windows based operating systems in other embodiments.

Components in addition to those shown in computer system 100 may also be implemented in different devices. For example, display device 10 may also include a camera configured to generate the camera images as photographs or video frames of the environment of the user.

In some AR applications, measuring the full 6 degrees of freedom (6DoF) pose is not used to provide useful Augmented content. In one embodiment, it may be sufficient to identify where an object is in image coordinates as opposed to physical space as described above. For example, an application may only require a bounding region. Another application may need to be as specific as identifying the individual pixels of the object. For example, an AR application may need to highlight all the pixels in an image that contain the object to call attention to it or provide additional information. In pose-less AR, the camera or object pose is not estimated, but it may be desired to identify the physical state of an object along with its location in the image. Training and application of deep neural networks for pose-less AR are discussed below. Tracking an object with pose-less AR is estimating the location of an object within a sequence of images.

In one embodiment, semantic pixel labeling may be performed on an image with a CNN. The end result is a per pixel labeling of objects in an image. The method may require training neural networks at different input image sizes. Then using sliding windows of various sizes to classify regions of the image. Finally the results of all the classifications may be filtered to understand the object of each pixel.

In another embodiment, a R-CNN may be utilized to find a bounding box around an object. This is the same concept that was identified earlier when doing multiple object tracking for pose-base AR solutions.

In another embodiment, pixel labeling may be done with a neural network where each input pixel corresponds to a multi-dimensional classification vector.

We refer to all neural network algorithms that perform localization of an object within an image as a localizers. Localizers take an image as input and output a localization of the object. Since they are based on neural networks they need training data specific to the objects they will localize. The discussion proceeds with an outline of how to train localizers for AR applications, then apply them to perform efficient detection and tracking of objects.

When a three-dimensional digital model of an object exists, it can be used to generate an unlimited amount of training images by generating a set of two-dimensional renders of the object. This is the same concept as presented above for pose-base AR. In one embodiment, a set of reflection maps are prepared ahead of time for producing realistic reflections on the object. Another set of background images are prepared to place behind the rendered object. For each training image, choose a random camera pose, reflection map, lighting environment (type and direction), physical state of object and background image, then render the scene. Instead of recording all these factors, as in some embodiments of pose-based AR, the combination of the object identifier and its physical state becomes a single label for the image. The result is a set of labeled images of the object without the manual labor of collecting photographs of the object. These training images are used to train the chosen localizer in one embodiment.

In some cases it may not be feasible to construct a digital model of the object. Photographs may be taken while creating a labels of the object name. If physical state is being estimated then photos from different angles should show the different physical states that need to be estimated. Each training image is labeled with the appropriate object identifier and physical state. These training images are used to train the chosen localizer in one embodiment.

Some aspects regarding application of pose-less AR are discussed below. As with pose-base AR, the camera image may be processed to remove distortions caused by the lens. This process may be implemented in the same manner as the pre-processing described above.

The region and pixel localization networks utilize a specific size image to process. The camera image may be scaled and cropped as described for pose-base AR in one embodiment.

As with pose-based AR, it may be more efficient to separate the detection and tracking process when analyzing an image sequence. The detection phase may include computing the localization on the entire camera image. Once the object is detected, it may be more efficient to look for the object in a restricted area of the image where it was last found. This assumes the object motion is small between successive video frames. Even when the assumption is broken, the detection phase may rediscover the object if it is still visible. Instead of doing a virtual camera transform to zoom into the image, a region in the camera image may be cropped during detection. If it is not found in the tracking step, then the detection phase restarts by scanning the entire image frame in one embodiment.

In one embodiment, the detection and tracking described above may be done entirely on the display device 10. If the processing time is too slow for a particular device 10, then the detection or tracking (or both) processes may be offloaded to the server device 30 that processes the video feed and provides the region localization back. The server device 30 may also return the augmented content. The display device 10 would send a camera frame to the server device 30, then the server device 30 would respond with the updated estimates. If the server device 30 also does the rendering of the augmented content, then it can provide back the localization along with a 2D frame containing the AR overlay.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended aspects appropriately interpreted in accordance with the doctrine of equivalents.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

What is claimed is:

1. An augmented reality computer system comprising:
processing circuitry configured to:
access an image of the real world, wherein the image includes a real world object; and
evaluate the image using a neural network to determine a plurality of augmented reality estimands which are indicative of a pose of the real world object and which are useable to generate augmented content regarding the real world object.

2. The augmented reality computer system of claim 1 wherein the neural network is a first neural network, and wherein the processing circuitry is configured to detect the real world object in the image and select the first neural network from a plurality of other neural networks as a result of the detection.

3. The augmented reality computer system of claim 1 further comprising communication circuitry configured to receive the image from externally of the computer system and to output the augmented reality estimands which are indicative of the pose externally of the computer system.

4. The augmented reality computer system of claim 1 further comprising communication circuitry configured to receive the image from externally of the computer system and to output augmented content regarding the real world object externally of the computer system.

5. The augmented reality computer system of claim 1 wherein the processing circuitry is configured to use the augmented reality estimands to generate augmented content regarding the real world object.

6. The augmented reality computer system of claim 5 wherein the processing circuitry is configured to control output of the augmented content externally of the computer system for conveyance to a user with respect to the real world object.

7. The augmented reality computer system of claim 5 wherein the processing circuitry is configured to use the augmented reality estimands to generate augmented content in accordance with the pose of the real world object.

8. The augmented reality computer system of claim 1 wherein the processing circuitry is configured to evaluate the image using the neural network to determine a plurality of the augmented reality estimands which are indicative of a type and direction of lighting of the real world object in the image.

9. The augmented reality computer system of claim 1 wherein the processing circuitry is configured to evaluate the image using the neural network to determine one of the augmented reality estimands which is indicative of a plurality of different states of the real world object.

10. The augmented reality computer system of claim 1 wherein the processing circuitry is configured to determine a location of the real world object in the image, to use the determined location in the image to select a subset of data of the image, and to use the subset of data of the image to determine the augmented reality estimands of the pose.

11. The augmented reality computer system of claim 10 wherein the subset comprises a plurality of pixels of the object and a plurality of pixels which are adjacent to the pixels of the object.

12. The augmented reality computer system of claim 10 further comprising determining a bounding box of the real world object in the image, and wherein the subset is defined by the bounding box.

13. The augmented reality computer system of claim 1 wherein the processing circuitry is configured to access metadata regarding the object from a model of the object as a result of the image including the real world object.

14. A neural network training method comprising:
accessing a plurality of training images of an object, wherein the object has different actual poses in the training images;
using a neural network, evaluating each of the training images to generate a plurality of first augmented reality estimands which are indicative of an estimated pose of the object in the respective training image;
for each of the training images, accessing a plurality of first values which are indicative of the actual pose of the object in the respective training image;
computing loss which is indicative of a difference between the first augmented reality estimands and the first values;
using the loss, adjusting a plurality of weights of connections between a plurality of neurons of the neural network;
using the neural network after the adjusting, evaluating each of a plurality of test images to generate a plurality of second augmented reality estimands which are indicative of an estimated pose of the object in the respective test image;
for each of the test images, accessing a plurality of second values which are indicative of the actual pose of the object in the respective test image;
comparing the second augmented reality estimands with the second values to generate error; and
using the error to determine whether the neural network has been sufficiently trained to identify the pose of the object.

15. The method of claim 14 wherein the adjusting comprises adjusting the weights to reduce the loss value.

16. The method of claim 14 wherein the accessing the training images comprises accessing as a result of a random selection of a subset of the training images.

17. An augmented reality method comprising:
using a camera, generating a plurality of camera images of the real world, wherein the camera images include an object in the real world;
using a neural network, evaluating each of the camera images to determine an augmented reality estimand which is indicative of a pose of the object with respect to the camera;
using the augmented reality estimand to generate augmented content; and
conveying the augmented content with respect to the object in the real world.
